(19) United States
(12) Patent Application Publication
(10) Pub. No.: US 2013/0068713 A1
(43) Pub. Date: Mar. 21, 2013

(54) LIFTING FRAME DEVICE

(71) Applicants: Joern Salthammer, Vestnes (NO); Yngve Bøe Myklebust, Molde (NO)

(72) Inventors: Joern Salthammer, Vestnes (NO); Yngve Bøe Myklebust, Molde (NO)

(73) Assignee: ROLLS-ROYCE MARINE AS, Alesund (NO)

(21) Appl. No.: 13/638,255

(22) PCT Filed: Mar. 31, 2011
(86) PCT No.: PCT/NO2011/000114

§ 371 Date: Nov. 29, 2012

(30) Foreign Application Priority Data
Mar. 31, 2010 (NO) 2010 0478

(51) Int. Cl. B66C 23/06

(52) U.S. Cl. CPC B66C 23/06
USPC 212/261

(57) ABSTRACT

A lifting device for handling and/or moving loads, including two vertical booms which via one of their ends are pivotally connected to a base and via their opposite ends are pivotally connected to a horizontal beam, forming a frame for the lifting device wherein at least one cylinder is connected to at least one of the vertical booms so as to be able to turn the lifting device around the pivot point. The horizontal beam is further pivotally connected to at least one tension rod. The vertical booms, the tension rods and the horizontal beam will then be pivotal in relation to each other. By means of the present invention, a less torque-critical lifting device is provided, as the vertical booms, when handling and/or moving a load, will take up compressive forces, while the tension rods will take up tensile forces.

Related cases: This case claims priority under 35 U.S.C. §119, 120 and/or 365 on Norway Patent Appln. No. 2010 0478 filed 31 Mar. 2010 and PCT/NO2011/000114 filed 31 Mar. 2011.

### FIELD OF THE INVENTION

The present invention relates to a lifting device for handling and/or moving loads, and more particularly the present invention relates to a lifting frame comprising at least one tension rod.

### BACKGROUND AND PRIOR ART

When moving or transferring loads offshore, where the moving or transfer may take place between two vessels, between a vessel and an offshore structure, or through the deployment/boarding of loads into/from the sea, a lifting device known as an A-frame is used. The A-frame is constituted of two side booms and a top boom, which side booms are connected to one or more cylinders. Furthermore, the A-frame is pivotally connected to an underlying surface. By controlling the stroke of the cylinders, the A-frame can be made to rotate about the pivotal connection. A lifting hook is further provided in the top boom, which lifting hook is connected to a lifting wire.

A conventional A-frame of this kind cannot, however, increase its lifting radius and/or lifting height. This means that the size of the load will determine whether the load can be moved or transferred. In addition, at the maximum lifting radius of the A-frame, the cylinders connected to the side booms will take up the whole load.

It is an object of the present invention to provide a lifting device with increased lifting radius and lifting height compared with conventional lifting device.

Another object according to the present invention is to provide a lifting device that is less torque-critical.

A further object of the present invention is to provide a lifting device capable of handling and moving loads in both the vertical and longitudinal direction.

These objects are achieved by means of a lifting device for handling and/or moving loads as disclosed in the following independent claim 1, with additional features of the invention set forth in the dependent claims and the description below.

### SUMMARY OF THE NEW INVENTION

The present invention relates to a lifting device for handling and/or moving loads, for example, handling, moving and transferring loads offshore, in which case the lifting device is provided on a vessel, preferably close to a rear end of the vessel. It should be understood, however, that the lifting device according to the present invention may conceivably also be used in other areas, for example, as a lifting de-vice arranged on the load platform of a vehicle, in a factory or warehouse etc. In one embodiment of the present invention, the lifting device comprises at least two vertical booms which via one of their ends are pivotally connected to a base arranged on an underlying surface and, via the opposite end thereof, are pivotally connected to a horizontal beam, in order thereby to form a frame in the lifting device. Each of the vertical booms is further connected to at least one cylinder, which at least one cylinder is also connected to a base arranged on the underlying surface. At least two tension rods are via one end thereof pivotally connected to the horizontal beam, which tension rods are then arranged and connected at or in proximity to the ends of the horizontal beam. The opposite ends of the tension rods are pivotally connected to a base which is arranged on the underlying surface. Through the above construction, a lifting device is provided which comprises a frame, where the vertical booms and the tension rods are pivotally connected to the horizontal beam.

It should be understood that a lifting device according to the present invention may comprise more than two vertical booms and/or tension rods, the number depending on the area of use of the lifting device, the stresses to which the device is subjected etc.

The pivotal connections between the different elements of the lifting device may be constituted of a bearing means or a swivel connection. It should however be understood that also other devices or means may be used to form the pivotal connections, provided that these devices or means allow a movement of the different elements in relation to each other.

In order to obtain an increased lifting radius and lifting height with the lifting de-vice according to the present invention, the horizontal beam, along its longitudinal direction, is configured with a plurality of projections, these projections serving as attachment points for the tension rods and fixation of a hook block. The projections are spaced apart in the longitudinal direction of the beam and on opposite sides, such that the tension rods will be connected to the projections on one side of the horizontal beam, whilst the hook block will then be pivotally connected to one or more projections on the opposite side of the horizontal beam. This arrangement will mean that, when seen in the longitudinal direction of the horizontal beam, the hook block and the tension rods will be arranged on opposite sides of the vertical booms and with a distance between them which is greater than the width of the horizontal beam.

The cylinders to which the vertical frames are connected are preferably hydraulic. However, it should be understood that also other devices can be used for this purpose, for example, pneumatic cylinders, telescopic rods etc. By extending or contracting the cylinders, it will be possible to operate and control the position of the lifting frame.

It should be understood that several hook blocks can be arranged in the lifting device, the hook blocks then being arranged after one another in the longitudinal direction of the horizontal beam. The hook blocks may be fixedly connected to the projections in the horizontal beam, so that they cannot be moved in the longitudinal direction of the horizontal beam, or the hook blocks may be arranged in such a way that they can be moved in the longitudinal direction of the horizontal beam. The use of several hook blocks will be expedient with respect to handling and/or moving heavy loads (the weight will be distributed over several lifting wires), long loads, for example, a pipe or container (several support points along the length of the load), when there is a large number of load units (moving of a plurality of load units simultaneously) etc.

The hook block comprises a lifting hook, which via a lifting wire is connected to at least one winch in a winch arrangement. The winch arrangement may then comprise a plurality of drums and winches, tensioning and/or braking means for the lifting wire and/or drums etc. If several lifting hooks are used in the lifting device, a winch arrangement may be used for each lifting hook; alternatively, the winch arrangement may be so designed that the lifting hooks are controlled simultaneously and identically. Since the winch arrangement is arranged at a distance from the lifting frame, at least one wire sheave or the like will be arranged between the winch and the hook block. The wire sheave is used to change the direction of the lifting wire, for example, from a horizontal to a vertical direction, and also to re-duce the friction in the lifting wire.

In one embodiment of the present invention, the lifting device is arranged on the deck of a vessel, in proximity to the stern of the vessel. The winch arrangement will in that case also be arranged on the deck. The lifting wire will then run essentially parallel to the deck of the vessel from the winch arrangement and in proximity to one of the vertical booms of the lifting device, whereafter a wire sheave in proximity to the vertical boom is used to pass the lifting wire from the horizontal to the vertical direction. One or more additional wire sheaves are arranged in proximity to the horizontal beam, thereby enabling the lifting wire to run over the horizontal beam in the right direction so as to be correctly connected to the lifting hook in the lifting block.

The base by which the vertical frames, tension rods and cylinders are connected to the underlying surface, may be constituted of a block, bracket or the like. The connection between the vertical frames, tension rods, cylinders and bases will then be a pivotal connection, which connection, as disclosed above, may be constituted of a bearing means, a swivel connection etc.

The lifting device according to the present invention may be arranged so as to be stationary or movable in relation to the underlying surface. If the lifting frame is stationary, the bases will be fixedly connected to the underlying surface, for example, the deck of a vessel. If the lifting frame is to be mobile, the bases and the lifting frame can be arranged on a frame which by means of wheels or rails can be moved in the longitudinal direction of the deck, or it is conceivable that the lifting device itself is equipped with a plurality of lockable wheels.

By means of the present invention there is provided a lifting device that is less torque critical than conventional lifting devices. When the lifting device is loaded, the vertical booms will take up compressive forces, whilst the tension rods will take up tensile forces. As a result, fewer cylinders can be used for movement of the lifting device. In addition, a lifting device is provided having increased lifting radius and lifting height compared with conventional lifting devices.

The invention will now be explained in connection with a number of embodiments and with reference to the attached figures.

### BRIEF DESCRIPTION OF THE DRAWINGS

FIG. 1 shows a lifting device according to the present invention arranged on a vessel;

FIG. 2 shows the actual lifting device shown in FIG. 1 in greater detail, in a side view and in a front view;

FIG. 3 shows the lifting device which is in the process of handling and moving a load;

FIG. 4 shows the lifting device in an extreme position, beyond the stern of the vessel, where the load is to be lowered; and

FIG. 5 shows the two extreme positions of the lifting device, from an inoperative and withdrawn position to an operative position beyond the stern of the vessel.

### DETAILED DESCRIPTION OF THE PREFERRED EMBODIMENT

For convenience and clarity in describing these embodiments, similar elements or components appearing in different figures will have the same reference numbers.

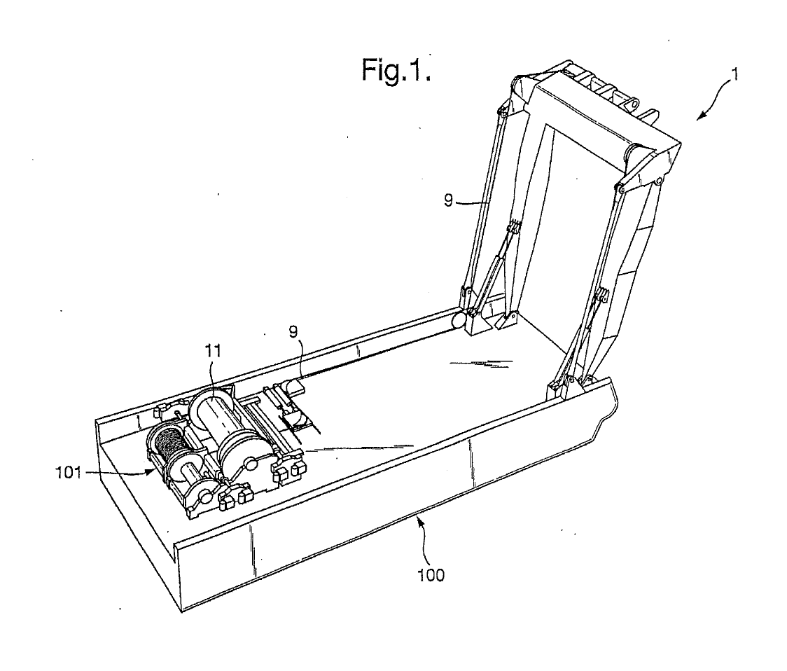

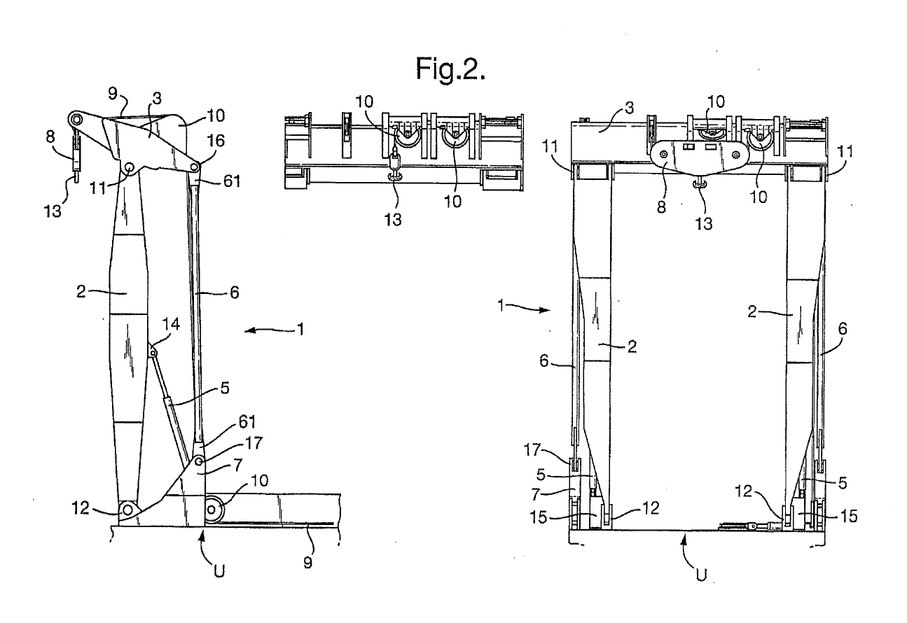

FIG. 1 shows a lifting device 1 according to the present invention, wherein the lifting device 1 is arranged on the deck of a vessel 100. The lifting device 1 is arranged at a rear end of the vessel 100. A winch arrangement 101, comprising a winch 11, is connected via at least one lifting wire 9 to the lifting device 1 hook block 8 (see also FIG. 2), such that a load L can be lifted up or down.

The winch arrangement 101 comprises a plurality of drums and winches 11, guiding and tensioning means (not shown) for the lifting wire 9, braking means (not shown) etc. Since the winch arrangement 101 is a conventional arrangement, it will not be described in more detail here.

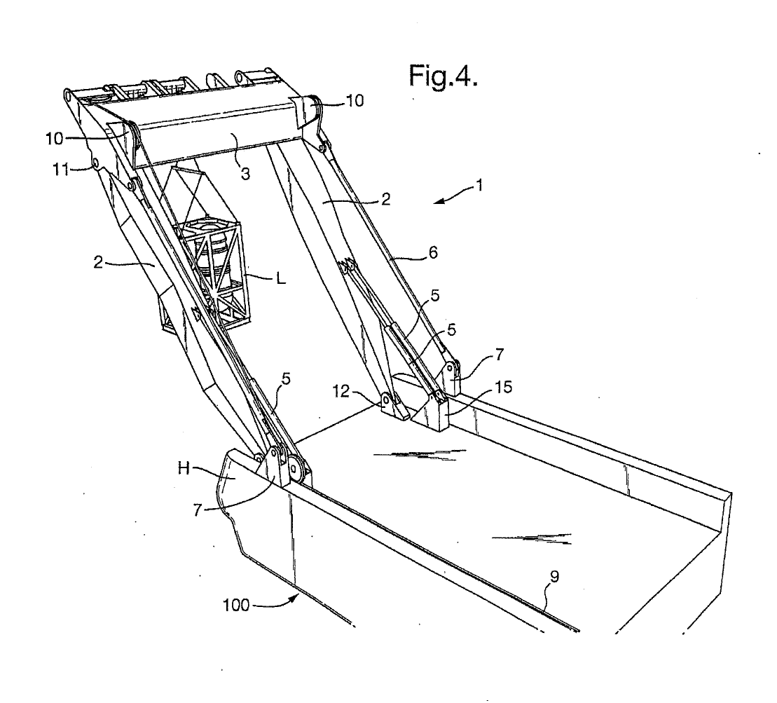

The lifting device 1 according to the present invention is shown in greater detail in FIG. 2, in a side view and a front view (i.e., in the longitudinal direction of the vessel 100, from the stern), where it is shown that the lifting device 1 comprises two vertical booms 2, which via one of their ends are pivotally connected to and form a first pivot point 11 with a horizontal beam 3, in order thereby to form a frame in the lifting device 1. The first pivot point 11 is constituted of a bearing, a swivel connection or the like. The other end of the vertical booms 2 is, in a similar manner, pivotally connected to and forms a second pivot point 12 with a base 12 on the underlying surface U on the vessel 100. The second pivot point 12 is, like the first pivot point 11, constituted of a bearing, a swivel connection or the like. In connection with the horizontal beam 3, there is provided a hook block 8, comprising a hook 13. The lifting wire 9 will then run from the winch 11, via a plurality of wire sheaves 10, to the hook 13. The lifting device also comprises two cylinders 5 and two tension rods 6, the cylinders 5 being connected to the vertical booms 2, whilst the tension rods are connected to the horizontal beam 3. It is also conceivable that more than one cylinder is connected to each of the vertical booms 2; see, for instance FIG. 4, where it can be seen that a vertical boom 2 is connected to two cylinders 5. Each vertical boom 2 will then be connected to a cylinder 5, where one end of the cylinder 5 is pivotally connected to the vertical boom 2 through an attachment lug 14. The other end of the cylinder 5 is pivotally connected to a base 15 on the underlying surface U. Similarly, each end of each tension rod 6 will be pivotally connected to the horizontal beam 3, one tension rod 6 at each end of the horizontal beam 3, forming a pivot point 16. The opposite ends of the tension rods 6 will be pivotally connected to a base 7 on an underlying surface U, forming a pivot point 17. The tension rods 6 will then be configured with attachment lugs 61, thereby allowing the tension rods 6 to be connected to the pivot points 16, 17 through a bolt connection (not shown).

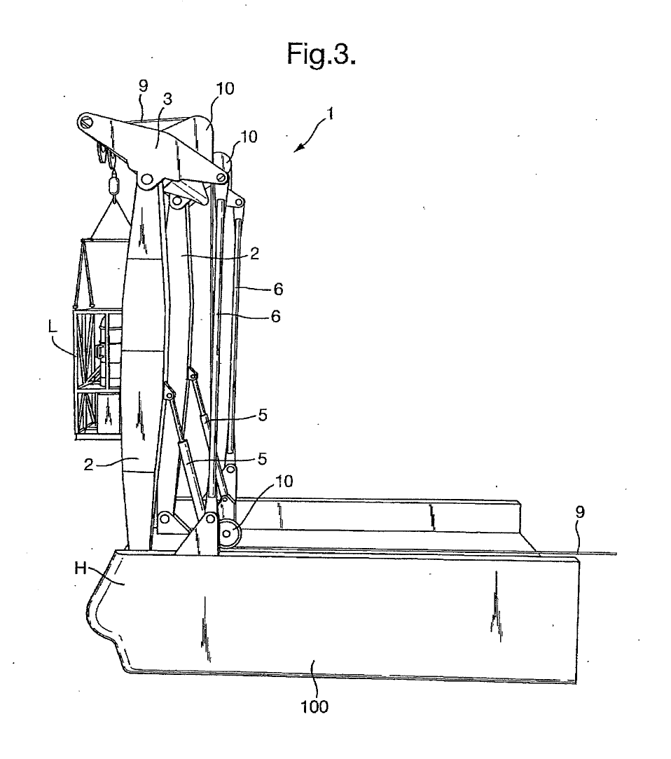

The cylinders 5 are suitably connected to a control device (not shown), so that an operator of the lifting device 1, by controlling the cylinders 5, can move the lifting device from the vertical position in which the lifting device 1 is shown in FIGS. 2 and 3, and to the position in which the lifting device 1 is shown in FIG. 4, i.e., an area beyond the stern H of the vessel 100.

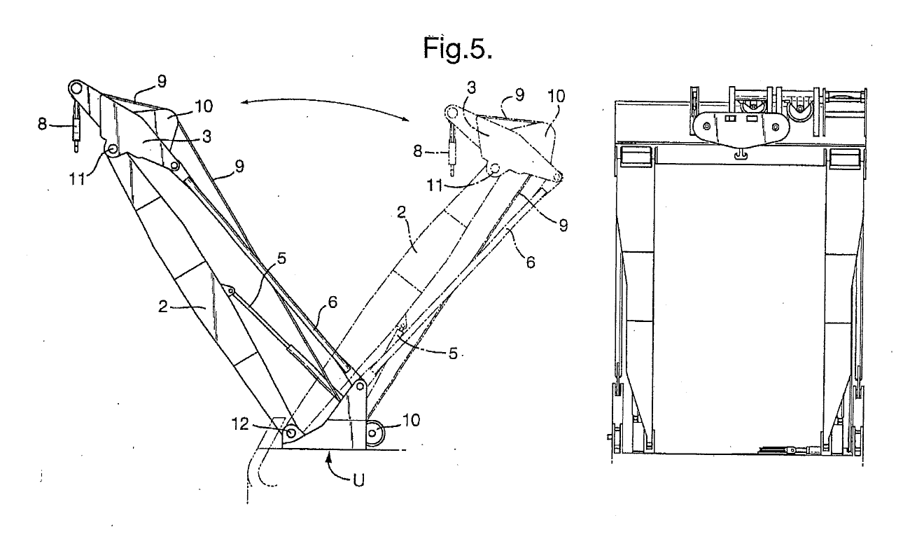

FIG. 3 shows the lifting device 1 in a vertical, intermediate position, an operator having lifted up a load L from the underlying surface U on the vessel 100. The operator has then moved the lifting device 1 from an inoperative and withdrawn position (shown in FIG. 5) to a position in which the load L has been lifted up a certain height in the lifting device 1. The operator has subsequently brought the lifting device 1 and the load L to the vertical position of the lifting device 1 as shown in FIG. 3. By extending the cylinders 5 further, the lifting device 1 will be brought to a position as shown in FIG. 4.

The lifting device 1 in FIG. 4 has been brought to an extreme position lying be-yond the vessel's 100 stern H, whereby the load L now can be lowered into the sea (not indicated), or down onto another vessel (not shown). As can be seen from the figure, one of the vertical booms (the right boom) 2 will be connected to two hydraulic cylinders 5, whilst the other vertical boom 2 will only be connected to one cylinder 5. It can also be seen from the figure that because of the connection with the tension rods 6, the horizontal beam 3, has been turned about the first pivot point 11, whereby the horizontal beam 3, through its design, has caused the hook block 8 to reach an increased lifting height compared with conventional lifting frames.

The working area of the lifting device 1 can be seen in FIG. 5, as the two extreme positions of the lifting device 1 are shown. In one of the extreme positions (to the right in the figure), the lifting device has been withdrawn to an inoperative position, where it is seen that the cylinders 5 also are in their retracted position. In the other extreme position (to the left in the figure), the lifting device has been moved to a position beyond the vessel's 100 stern H (see also FIG. 4), where the cylinders 5 have a maximum stroke. As a result, the horizontal beam 3, because of the connection with the tension rods 6, has been turned about the first pivot point 11, whereby the lifting device hook block 8 has been brought to a higher position than in the inoperative and retracted position of the lifting device 1.

The invention has now been explained with reference to a number of embodiments. Those of skill in the art will understand that several changes and modifications may be made to the illustrated embodiments, which fall within the scope of the invention as defined in the following claims. The lifting device can, for example, be arranged so as to be stationary on a base, or it may be arranged on a movable frame, thereby allowing the lifting device to be moved in a longitudinal direction. The lifting device may further be used on vehicles such as trucks, or it may be arranged in a warehouse, production hall etc. Furthermore, it should be understood that the lifting device may comprise several vertical booms and several tension rods and cylinders, the number being adapted to the load that is to be handled and/or moved, stresses to which the lifting device is subjected etc.

1-9. (canceled)

10. A lifting frame device, comprising at least two vertical booms which via one end are pivotally connected to a base and via an opposite end are connected to a horizontal beam in order thereby to form a frame, which frame is connected to at least one cylinder, characterized in that the horizontal beam is configured with a plurality of projections, where the lifting frame device further comprises at least two tension rods which via one end are connected to the projections on one side of the horizontal beam, which horizontal beam through a first pivot point and a pivot point is pivotally connected to the at least two vertical booms and tension rods, while at least one hook block is connected to one or more projections on the opposite side of the horizontal beam.

12. A lifting device according to claim 1, characterized in that an opposite end of the at least two tension rods is pivotally connected to a base on the underlying surface (U).

13. A lifting device according to claim 1, characterized in that the pivotal connection is constituted of a bearing, a swivel connection or the like.

14. A lifting device according to claim 1, characterized in that a lifting hook in the hook block is connected via a lifting wire to a least one winch in a winch arrangement.

15. A lifting device according to claim 4, characterized in that at least one wire sheave is arranged between the winch and the hook block.

16. A lifting device according to claim 1, characterized in that the base is constituted of a frame, a block, bracket or the like.

17. A lifting device according to claim 1, characterized in that the base is fixedly connected to or movable in relation to the underlying surface (U).

18. A lifting device according to claim 2, characterized in that the base is fixedly connected to or movable in relation to the underlying surface (U).

19. A lifting device according to claim 6, characterized in that the base is fixedly connected to or movable in relation to the underlying surface (U).

20. A lifting device according to claim 1, characterized in that the hook block is pivotally connected to the horizontal beam.
